(19) United States
(12) Patent Application Publication
(10) Pub. No.: US 2009/0103150 A1
(43) Pub. Date: Apr. 23, 2009

(54) Object Having a Holographic Security Feature and Method for Manufacturing Such a Feature

(76) Inventors: Rene Heierli, Winterthur (CH); Martin Eichenberger, Zollikon (CH)

Correspondence Address: LADAS & PARRY LLP, 26 WEST 61ST STREET, NEW YORK, NY, 10023, US

(21) Appl. No.: 11/794,030

(22) PCT Filed: Jan. 11, 2005
(86) PCT No.: PCT/CH05/00008

§ 371 Date: Oct. 25, 2007

(51) Int. Cl. G03H 1/18; G07D 7/12

(52) U.S. Cl. 359/2; 430/2

(57) ABSTRACT

An optical security feature, e.g. for a banknote or other security documents, comprises a first and a second holographic layer arranged on top of each other. Each layer comprises a comparatively simple reflective volume hologram, such as it can e.g. be recorded by the interference pattern of two Gaussian light beams. The volume holograms have different grating spacing and/or orientation as well as different extension such that the observer can distinguish and verify them easily. The simple nature of the holograms make the security feature easy to manufacture, while its two-layer structure makes it hard to copy and yields high diffraction efficiency.

### TECHNICAL FIELD

The invention relates to an object having a holographic security feature with a first holographic layer comprising a first reflective volume hologram and a second holographic layer on top of said first holographic layer comprising a second reflective volume hologram. The invention also relates to a method for manufacturing such a security feature.

### BACKGROUND ART

It has been known to use holograms in security features for counterfeit protection.

U.S. Pat. No. 6,529,297 relates to a hologram with three reflection volume holograms recorded with diffuse light to generate three diffuse light spots of different color at three different perceptual positions.

### DISCLOSURE OF THE INVENTION

It is a general aim of the invention to provide a an object with a security feature of this type having several volume holographic layers that is easy to manufacture and to verify. It is also an aim of the invention to provide a method for manufacturing such a security feature.

Now, in order to implement these and still further objects of the invention, which will become more readily apparent as the description proceeds, in a first aspect of the invention, the first as well as the second volume hologram each correspond to the interference pattern between two Gaussian beams. A true “Gaussian beam” is a light beam with substantially spherical phase planes and a Gaussian intensity distribution—in the context of the present application, however, a true Gaussian beam that is partially masked after passage through a mask cutting off part of the light at its periphery is still considered to be a Gaussian beam.

In a manufacturing method according to this first aspect of the invention, each holographic layer is illuminated by means of two coherent Gaussian beams for generating the first and second reflective volume hologram, respectively.

A special case of a Gaussian beam is a plane wave. In the sense of the definition above, a plane wave passing through a mask cutting it off peripherally will still be considered to be a plane wave.

Hence, in a second aspect of the invention, the first as well as the second volume hologram is a homogeneous Bragg diffraction grating with a given grating vector. Each such volume hologram can be created by recording the interference pattern of two plane waves. The grating vectors of the first and second volume holograms are different in direction and/or length, which causes them to reflect light of different colors or into different directions. Hence, such holograms are not only easy to manufacture, but can also distinguished and to verified with ease.

Similarly, in a third aspect of the invention, the first and second volume holograms reflect light in a first and a second range of directions, respectively, wherein said first and said second range are different. Hence, again, such holograms are easily to distinguish and to verify. Preferably the first and the second range are non-overlapping, which allows to distinguish the reflections from the two layers easily.

Advantageously, in all aspects of the invention, under an illumination with diffuse white light, the maximum reflectivity of the first hologram should be in a different direction and at a different wavelength from the maximum reflectivity of the second hologram. This allows to verify the holograms by viewing the object from different angles while illuminating it with diffuse white light. Depending on the viewing angle, a differently colored reflection from the first or the second holographic layer is predominant.

In a further advantageous embodiment of the above aspects of the invention, the first and second hologram have different shape. In other words, in directions parallel to the holographic layers, the spatial extension of the first hologram is different from the spatial extension of said second hologram. In this case, the holograms will “light up” with different shapes when viewed from the appropriate directions, which again makes the reflection from the first hologram easy to distinguish from the reflection from the second hologram.

The object can advantageously be a banknote or some other security document, such as a passport, ID card, driver's license, check, credit card, packaging, tags for valuable goods, data carriers, or letter heads that should be hard to counterfeit.

In the context of this application, a holographic layer with a “reflective” volume hologram is understood to designate a layer with a volume hologram that, when illuminated with reading light from a first side of the layer, reflects light back to exit from the first side of the layer. This means that the grating vector(s) of the hologram are such that the Bragg condition is fulfilled for incoming light incident through the first side and exiting light exiting through the same first side.

The term “homogeneous Bragg diffraction grating” is used in the present application to designate a volume hologram consisting of a Bragg diffraction grating having the same grating vector over the whole hologram. The amplitude of the grating may vary over the holographic layer, and the grating may even be absent in parts of the holographic layer, but the direction and distance of the grating planes are the same all over the holographic layer wherever the grating exists.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 shows a banknote having a holographic security feature,

FIG. 2 is a sectional view along line II-II of FIG. 1,

FIG. 3 shows the writing of a holographic layer by means of plane waves, and

FIG. 4 shows the writing of a holographic layer by means of divergent Gaussian beams.

### MODES FOR CARRYING OUT THE INVENTION

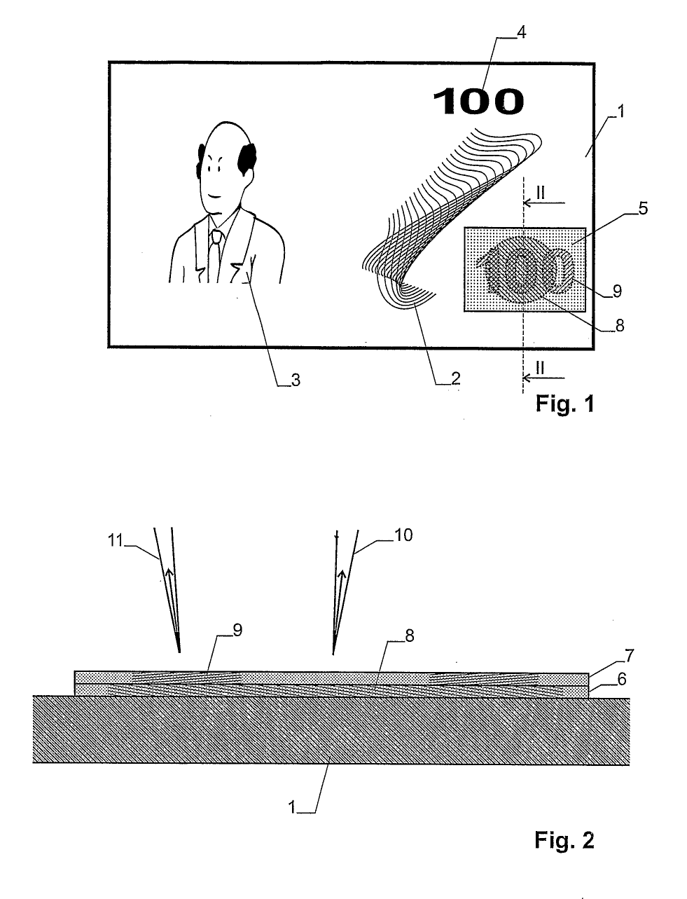

FIG. 1 shows an object according to the present invention in the form of a banknote. The banknote has a carrier 1 of a thin, flexible material, such as paper, with various conventional security features 2, images 3 and textual matter 4 applied thereto. It further comprises a security feature 5, which will be described in the following.

As can best be seen from FIG. 2, security feature 5 comprises two (or more) holographic layers 6, 7. First holographic layer 6 is arranged on top of carrier 1 and attached thereto. Second holographic layer 7 is arranged on top of first holographic layer 6.

Each holographic layer 6, 7 comprises at least one reflective volume hologram 8, 9, respectively. The spatial extensions of the holograms 8, 9 in the directions parallel to the holographic layers 6, 7 differ from each other. In the embodiment of FIGS. 1 and 2, first hologram 8 extends to fill a circle while second hologram 9 extends to fill the glyphs “100”.

Both volume holograms 8, 9 are reflective volume holograms in the sense above, i.e. when carrier 1 is illuminated from the side carrying security feature 5, the holograms reflect light back. FIG. 2 shows, schematically, the angular ranges 10, 11 of reflections from hie first and second volume hologram 8, 9, respectively upon illumination with diffuse white light. Advantageously, the ranges 10, 11 differ, and are preferably nonoverlapping, in order to allow the viewer to easily distinguish the light reflected from the different volume holograms 8, 9.

In the embodiment of FIGS. 1 and 2, both volume holograms 8, 9 are homogeneous Bragg diffraction gratings, i.e. they are formed by periodic variations of the refractive index and/or absorption of the hologram layers. Such periodic variations are generally described by a (location dependent) local amplitude and grating vector. In a homogeneous Bragg diffraction grating, in the sense used here, the grating vector of a given hologram is the same everywhere, i.e. the orientation and grating spacing remains the same over the whole hologram, while the amplitude may depend on the position within the hologram. For example, in the first volume hologram 8 the amplitude is a fixed value within the circle while it drops to zero outside the circle.

The grating vectors of the two volume holograms 8, 9 differ in direction and/or size, thereby giving rise to the different reflection ranges 10, 11 and/or different reflection colors.

In general, when viewing the embodiment of FIGS. 1 and 2 under diffuse white light illumination, the reflection from first volume hologram 8 can be seen from a first angular range 10 in a first spectral range, while the reflection from second volume hologram 9 can be seen from a second angular range 11 in a second spectral range. In general, the angular and spectral ranges of the light from the two volume holograms 8 will differ.

The intensity, angular range and spectral range of the reflected light will generally depend on a plurality of parameters, such as the grating vector and amplitude, the refractive index of the holographic layers and the thickness of the holograms.

By placing the two volume holograms 8, 9 in separate holographic layers instead of superimposing them in a single layer, the reflection efficiency can be increased while the thickness of the holograms can remain small. A small hologram thickness is advantageous because thick holograms have higher angular selectivity and are therefore more difficult to observe.

To obtain a reflection that can be observed easily, an advantageous thickness of the volume holograms 8, 9 is between 10 and 15 μm for each hologram, even though thicker or thinner holograms can be used depending on the desired optical properties of security feature 5.

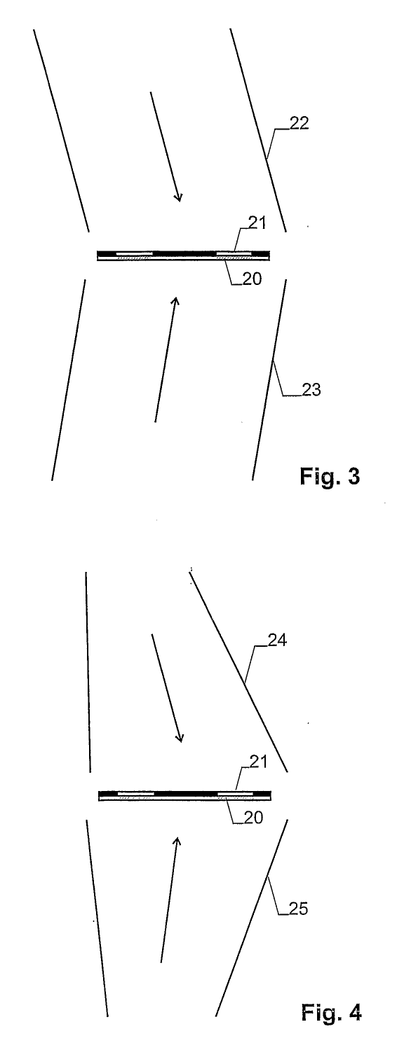

A method for manufacturing the volume holograms of FIGS. 1 and 2 is depicted in FIG. 3. In the proposed procedure, the volume holograms 8, 9 are manufactured separately from each other by illuminating a single photosensitive holographic layer 20 (which can be one of the layers 6, 7 or a separate master hologram as known to the person skilled in the art) by an interference pattern of two coherent, monochromatic plane waves 22, 23. In order to structure the hologram laterally, a mask 21 can be placed at least at one side of holographic layer 20. Mask 21 prevents the formation of interference patters outside the desired regions of holographic layer 20.

During illumination, holographic layer 20 may be arranged on a substrate or between a pair of suitable substrates (not shown).

Instead of masking the areas where no formation of a hologram is desired, these areas can first be illuminated by homogeneous light, whereupon the whole holographic layer 20 is brought into an interference pattern: In this case, the interference pattern is only recorded in the regions that have not been illuminated before.

After illumination, mask 21 can be removed and the hologram can be fixed within holographic layer 20, e.g. by thermal, chemical or photochemical treatment.

The details of the recording and fixing of the hologram depend on the recording material used in holographic layer 20. Various such recording materials are known, see e.g. WO 03/036389.

In order to manufacture the security feature 5 of FIGS. 1 and 2, two such holographic layers 20, each with a hologram of the desired shape and orientation, can be prepared and then laminated to each other and to carrier 1.

Because the manufacturing step depicted in FIG. 3 uses simple plane waves 22, 23 in combination with a mask 21, it can be carried out easily. A method of comparable ease is illustrated in FIG. 4, where two Gaussian beams 24, 25 are used instead of plane waves. As known to the person skilled in the art, Gaussian beams 24, 25 are as easy (and sometimes easier) to prepare as plane waves. In contrast to plane waves, the phase planes of Gaussian beams are generally curved and the beams are convergent or divergent.

The holograms manufactured in this way correspond to the interference pattern between the two Gaussian beams and will, in general, have a local grating vector that varies accordingly. When viewed in diffuse white light, the reflected light from the holograms will again substantially correspond to a Gaussian beam.

In the manufacturing methods of FIGS. 3 and 4, the holographic layers 6, 7 are manufactured separately and then assembled to form the security feature 5, which can then be applied to carrier 1. Alternatively, first holographic layer 6 can first be applied to carrier 1, and then second holographic layer 7 can be applied to the top of first holographic layer 6.

Advantageously, security feature 5 is applied to a “dark” part of carrier 1, e.g. to a part where carrier 1 carries a dark printed pattern, which improves the visibility of the light reflected from the volume holograms 8, 9. In other words, for best results, security feature 5 should be arranged over an area of carrier 1 that has a reflectivity smaller than a maximum reflectivity of the volume holograms 8, 9. If the volume holograms 8, 9 have different reflectivity, the reflectivity of carrier 1 in the area of security feature 5 should be smaller than the maximum reflectivity of first holographic layer 6 and smaller than the maximum reflectivity of second holographic layer 9. The carrier 1 in the region of the security feature should be non-transparent.

In the embodiment of FIGS. 1 and 2, the holographic layers 6, 7 are arranged on top of carrier 1. Alternatively, one or both of the layers 6, 7 can be embedded into carrier 1.

As results from the above, the security feature according to the present invention can be manufactured and verified easily. Its multi-layer nature with different volume holograms in different layers make counterfeiting and copying difficult. In particular, the reproduction of the multi-layer structure using a holographic contact copy process is difficult.

Since the volume holograms 8, 9 are manufactured separately in separate holographic layers 6, 7, it becomes possible to subject the holographic layers 6 to different post-processing steps. For example, each layer 6, 7 can be recorded using the same laser with the same beam geometry, but one holographic layer can subsequently be subjected to a shrinking process, e.g. by thermal or chemical treatment, thus changing its grating vector as compared to the grating vector of a non-shrunk layer.

While there are shown and described presently preferred embodiments of the invention, it is to be distinctly understood that the invention is not limited thereto but may be otherwise variously embodied and practiced within the scope of the following claims.

1. An object having a holographic security feature, said object comprising
a carrier,
a first holographic layer comprising a first reflective volume hologram,
a second holographic layer on top of said first holographic layer comprising a second reflective volume hologram,
wherein, each of said first and second volume holograms corresponds to the interference pattern between two Gaussian beams.

2. An object having a holographic security feature, in particular of claim 1, said object comprising
a carrier,
a first holographic layer comprising a first reflective volume hologram,
a second holographic layer on top of said first holographic layer comprising a second reflective volume hologram,
wherein, each of said first and second volume holograms is a homogeneous Bragg diffraction grating with a given grating vector, wherein the grating vectors of said first and second volume holograms are different in direction and/or length.

3. An object having a holographic security feature, in particular of claim 1, said object comprising
a carrier,
a first holographic layer comprising a first reflective volume hologram,
a second holographic layer on top of said first holographic layer comprising a second reflective volume hologram,
wherein, for diffuse illumination, said first and second volume holograms reflect light in a first and a second range of directions, respectively, wherein said first and said second ranges are different.

4. The object of claim 3, wherein said first and said second ranges are non-overlapping.

5. The object of claim 3, wherein under diffuse illumination with white light, a maximum reflectivity of the first reflective volume hologram is in a different direction and at a different wavelength from a maximum reflectivity of the second reflective volume hologram.

6. The object of claim 3, wherein said first holographic layer is arranged on top of said carrier.

7. The object of claim 3, wherein in directions parallel to said holographic layers, a spatial extension of said first reflective volume hologram is different from a spatial extension of said second reflective volume hologram.

8. The object of claim 3, wherein said object is a security document, in particular a banknote.

9. The object of claim 3, wherein the security feature is arranged over an area of said carrier that has a reflectivity smaller than a maximum reflectivity of said first holographic layer and smaller than a maximum reflectivity of said second holographic layer.

10. The object of claim 3, wherein a thickness of each of the reflective volume holograms is between 10 and 15 μm.

11. A method for manufacturing a security feature for an object, said method comprising the steps of
illuminating a first holographic layer for generating a first reflective volume hologram therein,
illuminating a second holographic layer for generating a second reflective volume hologram therein, and
adjoining the first and the second holographic layers,
wherein each of said first and second holographic layers is illuminated by means of two coherent Gaussian beams, in particular with two coherent plane waves, for generating said first and second reflective volume hologram, respectively.

12. The method of claim 11, wherein at least one a first of said holographic layers is subjected to a shrinking process for changing a grating spacing of said first holographic layer in respect to the second holographic layer.
